(19) United States
(12) Patent Application Publication
(10) Pub. No.: US 2022/0238887 A1
(43) Pub. Date: Jul. 28, 2022

(54) A LAMINATE, A BATTERY AND A METHOD

(71) Applicant: LEAPAGRO APS, Copenhagen K (DK)

(72) Inventors: Jens Wagonblast Stubbe OSTERGAARD, Roskilde (DK); Johannes Anders SMITH, Copenhagen K (DK)

(21) Appl. No.: 17/614,230

(22) PCT Filed: May 28, 2020
(86) PCT No.: PCT/EP2020/064866

§ 371 Date: Nov. 24, 2021

(30) Foreign Application Priority Data
May 28, 2019 (DK) PA 2019 70349

(51) Int. Cl. H01M 4/62; H01M 50/543; H01M 4/134; H01M 10/04

(52) U.S. Cl. CPC H01M 4/626; H01M 50/543; H01M 2004/027; H01M 10/0431; H01M 4/134

(57) ABSTRACT

A laminate for a battery and a battery with the laminate, where the anode and/or cathode layer is a single layer where anode or cathode material particles are interconnected by an electrically conducting element.

The present invention relates to improvements in battery technology and in particular to the laminate in so-called jelly-roll batteries.

In standard jelly-roll batteries, three overall layers are provided: the anode, the cathode and a separator provided between the anode and cathode. Usually the anode and cathode are formed by at least two layers, as the overall anode layer, as one layer, has the material for emitting positive ions which are to travel to the cathode layer, as the other layer, which will receive the positive ions. A reaction to this is that a current is created from the anode to the cathode. This current is that for which the battery is used. However, the usual anode material and cathode material are poor electrical conductors so that the current created has difficulties. Therefore, the electrodes (anode and cathode) material usually is laminated with a metallic current collecting layer which then handles the current transport.

A number of disadvantages exist, however, in that laminate type. Firstly, the high number of layers complicates the production process. Secondly, the anode/cathode layer is usually made from powder(s) and polymeric adhesive mixed into a slurry.

The present invention relates to advantages in this respect.

In a first aspect, the invention relates to a laminate for use in a battery, the laminate comprising:

a first electrode layer,
a second electrode layer and
a separator provided between the first electrode layer and the second electrode layer,
wherein at least one of the first and second electrode layers comprises particles of a predetermined material and an electrically conducting material interconnecting the particles.

In the present context, a laminate is a product having a number of layers which are at least substantially parallel and co-existing so that a main surface of one layer faces that of another layer. Usually, the layers of the laminate touch or engage but need not be attached to each other.

A battery is a charge holding device usually comprising a chemistry which is configured to output a current.

The electrode layers form anode layer and cathode layer which are configured to cooperate and have an ion interchange facilitating the current out of or into the battery.

The separator has the function of allowing the ion transport but preventing direct, electrical contact between the anode layer and the cathode layer. Separators may be made of polymers, Kevlar, ceramics or the like.

Both electrodes of the laminate may be of the new type, or only one thereof where the other may be of the known multi-layer type.

The electrode layer comprises a predetermined electrode material, which may be suitable for use as an anode material or a cathode material. This material may be any known or suitable anode or cathode material. The material is provided as particles, which may have any desired size, size distribution and shape. Particles may thus also be fibre shaped if desired. In some embodiments, more oblong or less round or rounded particles may be preferred, as these are more easily attached to e.g. a metal surface.

Providing the material as particles offers a large surface which is of interest in batteries as the ions need space to intercalate into. The electrically conducting material interconnects the particles.

Historically, this interconnection was facilitated using a polymer binder. It may be desired to still use a certain amount of such binder in addition to the use of the conducting material for the same purpose.

The conducting material has the additional purpose of conducting current from the electrode material particles toward/from e.g. a terminal of a battery employing the laminate.

In this context, an electrically conducting material is a material with an electrical resistivity of at no more than 100000, such as no more than 10000, such as no more than 500 μΩcm at 273K. Usual conducting materials are metals, such as aluminium, cupper, tin, antimony, nickel, silicon, or magnesium. However, also semiconducting materials such as Silicon may be used. It is preferred that the material has a rather low melting point and is malleable and is functional in the electrode as an anode or cathode material.

The interconnection of the particles may be achieved in many manners, which will be described further below. Usually, electrically conductive materials are more or less soft and may be moulded on to or around particles. This process may be assisted when heating the conducting material and/or using pressure.

The interconnection means that the material particles engage or are fixed in relation to each other and the conducting material.

The electrode may be a battery anode. Usual anode materials may be:
Lithium titanium oxide (Li₄Ti₅O₁₂; LTO)
Carbon-coated lithium titanium oxide (C-LTO)
Silicon-graphite (Si—C) composites with different mass ratios
Silicon monoxide nanowire (SiOₓ-NW)
Silicon monoxide nanowire-graphite (SiOₓ-C) composite
Tin oxide (SnO₂)/doped tin oxide
Graphite
Cu₂Sb
NiSb
ZnSb
MoSb
MnSb
InSb
AgSb
MgSb
TiSb
VSb
CrSb

The electrode may alternatively be a battery cathode. Typical cathode materials are:
Lithium cobalt oxide (LiCoO₂; LCO)
Lithium nickel cobalt oxide (LiNi_{0.8}Co_{0.15}Al0.0₅O₂; NCA)
Lithium manganese oxide (LiMn₂O₄; LMO)
Lithium (excess) manganese oxide (Li₂MnO₃)
Doped lithium manganese oxide (LiMn₂₋ₓMₓO₄)
Lithium manganese nickel oxide (LiMn_{1.5}Ni_{0.5}O₄; LMNO)
Lithium manganese nickel cobalt oxide composite (Li₁₊ₓMnₓNi_{y}Co_{z}O₂)
Iron Phosphate (FePO₄; FP)
Aluminium phosphate (AlPO₄)
Lithium cobalt phosphate (LiCoPO₄)
Lithium iron phosphate (LiFePO₄; LFP)
Doped lithium cobalt phosphate (LiCo₁₋ₓMₓPO₄; M: Mn, Fe, Co, V, Gd, Mg)
Ti-doped lithium manganese nickel oxide (LiMn₁₋ₓTiₓNi₅O₄; LTMNO)
Iron disulfide (FeS₂)
Titanium disulfide (TiS₂)
Sodium manganese oxide (Na_{0.44}MnO₂; Na₂Mn₅O₁₀)
Sodium manganese nickel oxide (NaMn₂₋ₓNiₓO₄)
Doped sodium manganese nickel oxide (NaNi_{0.33}FeₓMn_{0.333}Mg_{y}Sn_{z}O₂)
Sodium cobalt oxide (NaₓCoO₂)
Sodium iron manganese oxide (Naₓ[Fe_{0.5}Mn_{0.5}]O₂)
Sodium lithium nickel manganese oxide (Na_{0.85}Li_{0.17}Ni_{0.21}Mn_{0.64}O₂)
Sodium iron phosphate (NaFePO₄-Olivine)
Sodium cobalt mixed phosphates (Na₄Co₃(PO₄)₂P₂O₇)
Sodium cobalt manganese nickel mixed phosphates (Na₄Co_{2.4}Mn_{0.3}Ni_{0.3}(PO₄)₂P₂O₇)
Sodium iron mixed phosphates (Na₄Fe₃(PO₄)₂P₂O₇)
Sodium iron sulfate (NaFe(SO₄)₂; Eldfellite mineral)

Various oxide nanofibers can be synthesized. Notable examples includes ZnO, CuO, NiO, TiO₂, SiO₂, Co₃O₄, Al₂O₃, SnO₂, Fe₂O₃, LiCoO₂, BaTiO₃, LaMnO₃, NiFe₂O₄ and LiFePO₄.

Functional materials (molecules or nanoparticles) can be easily doped or incorporated into nanofibers by adding these materials or their precursors to the spinning solutions.

Electrospinning technique can also be used for fabricating nanofibers composed by non-oxide ceramics including carbide, boride, nitride, silicide and sulphide.

The electrospinning technique coupled with a thermal treatment approach, ZnS nanofibers can be prepared by sulfurizing the electrospun ZnO nanofibers (as a template) at 500 in an H₂S atmosphere.

Electrospinning a ceramic nanofibre, which has extremely high surface area according to its small size and provides fast charge-transfer channels along its 1D nanostructure, has been considered as an ideal material system for energy storage applications. High performance lithium ion battery electrode based on electrospun vanadium oxide nanofibers. Ultralong hierarchical vanadium oxide nanowires (Cathode) have been manufactured with a diameter of 100-200 nm and a length up to several millimeters using the low-cost starting materials by electrospinning combined with annealing. The hierarchical nanowires were constructed from attached vanadium oxide nanorods of diameter around 50 nm and length of 100 μm. The initial and 50th discharge capacities of the ultralong hierarchical vanadium oxide nanowire cathodes are up to between 390 and 201 mAh/g when the lithium ion battery cycled between 1.75 and 4.0 V. Ultralong hierarchical vanadium oxide nanowires exhibit high capacity due to self-aggregation and because the effective contact areas of active materials, conductive additives, and electrolyte realize the advantage of nanomaterial-based cathodes. This demonstrates that ultralong hierarchical vanadium oxide nanowires is one of the most favourable nanostructures as cathodes for improving cycling performance of lithium ion batteries.

It is noted that the electro spinning approach opens a wide avenue for cheap strong lightweight materials that can be melt fused together to form a matrix inside battery electrodes.

To ensure that the Vanadium oxide nanowires perform optimally electrically to avoid the need for addition of metals, the nanowires can be supplied with par example CNT's or Graphene for better conductivity and Fluorographene for better Chargeholding capacity.

The approach to melt fuse include radiative heating (such as using a programmable femtosecond laser to form an internal matrix of molten material that is fused together), compressive melting (calendar roll pressure), induction heating, conductive heating and the like is helpful.

In general, the electrically conducting material may comprise aluminium, lithium, nickel or magnesium or alloys comprising one or more of these materials. A number of electrically conducting materials are known for use with a cathode.

In general, the electrically conducting material comprises between 2 and 40, such as 10-30%, by volume, of the electrode material.

One of the advantages of the present electrode layer is that it may be more rugged and less rupture prone than legacy layers for battery laminates. The use of the electrically conducting material may allow folding and rolling of the layer without causing it to break.

In one embodiment, the laminate is folded so as to have an anode layer exposed on both major surfaces of the laminate. In this situation, the laminate may be further bent, folded or rolled with more freedom as only the anode layer is exposed. Desired additional folding may be a z folding or serpentine folding. A rolling is seen in round batteries. When folding the anode layer and the separator, the cathode layer need not be bent. It may instead have half the size and still be positioned within the bent separator. Folding and the like may be seen in Applicant's co-pending application with the title “A casing, battery, a method of manufacturing a battery and methods of operating the battery” and filed on even date. This application is incorporated herein by reference.

A second aspect of the invention relates to a battery comprising a laminate according to the first aspect of the invention, the laminate being provided in a casing having a first and a second terminal, the first terminal being connected to the first electrode layer and the second terminal being connected to the second electrode layer.

Clearly, all aspects, embodiments and situations may be combined in any desired manner.

The terminals of a battery may be provided at two opposite ends thereof, such as is often seen in hard case batteries. Alternatively, the terminals may be provided at the same end if desired. In pouch type batteries, the terminals are often provided in the form of a cable connected to the pouch. An interesting casing is described in Applicants above-mentioned application.

The casing thus may be a hard casing or a soft pouch. The casing may have additional components, such as vents and current interruption devices as well as different coatings and the like.

A third aspect of the invention relates to a method of manufacturing a laminate for a battery, the method comprising:

providing particles of a solid electrode material,
providing an amount of a predetermined electrically conducting material,
having the electrically conducting material interconnect the particles to form a first electrode layer,
providing a laminate with the first electrode layer, a second electrode layer and a separator provided between the first electrode layer and the second electrode layer.

An aspect of the invention is the electrode layer itself not in a laminate.

In general, the step of having an electrically conducting material interconnect the particles will be described further below.

Lamination may simply be a relative positioning of the layers. Often, the layers are laminated and rolled on to a roll for storage and subsequent feeding.

In one embodiment, the step of providing the electrically conducting material comprises providing fibres of the electrically conducting material, and wherein the interconnecting step comprises providing the fibres as woven structure and providing the particles therein or thereon. In this manner, the woven structure may be used for ensuring a good distribution of the conducting material in relation to the particles. Also, the woven structure may define suitable electrically conductive paths along which current may travel from the particles and to a delivery position, such as a battery terminal.

In another embodiment, the step of providing the electrically conducting material comprises providing fibres of the electrically conducting material, and wherein the interconnecting step comprises providing the fibres as non-woven structure and providing the particles therein or thereon. In general, the same advantages may be obtained in this situation.

A further alternative is to provide the electrically conducting material as a powder itself, or as fibres. Then, the conducting material and the particles may be mixed so that particles are close to the conducting material, which may then, see below, be forced toward the particles to arrive at the adherence desired.

Another alternative would be to provide the particles and add the conducting material by sputtering, ion plasma deposition or the like, which will operate to provide a thin layer, continuous or not, of the conducting material on the particles. This layer may then be forced toward the particles, or vice versa, to arrive at the adherence.

It may be desired to arrive at a predetermined concentration or distribution of the conducting material over the particles or a layer thereof. It may be desired to have an uneven distribution such that a higher amount or density of conducting material is close to a delivery position of the layer, whereas the concentration reduces further away from this position.

In one embodiment, the conducting material is magnetized or polarized and is affected by an electrical or magnetic field to seek toward a surface for building the layer. The particles may be so too.

In that manner, the field may be used for controlling the position and distribution of the conducting material.

In one embodiment, the interconnecting step comprises heating the conducting material and the particles to have the electrically conducting material act as a binder binding the particles after cooling. When heated sufficiently, the conducting material may soften so that a better adherence may be obtained. In addition, fibres/flakes or particles of the conducting material may be better interconnected to arrive at a lower thermal and electric resistance and thus a better current transporting ability.

In another embodiment, the interconnecting step comprises compressing the conducting material and the particles to have the electrically conducting material act as a binder binding the powder. This may arrive at the same result in that the compression may deform the conducting material to arrive at the adherence or interconnection desired.

In general, the electrically conducting material acts to interconnect the particles of the electrode layer. The conducting material may be mixed, as particles, fibres or flakes, with the electrode material particles and sufficiently treated to arrive at the interconnection. This treatment may be a heating. The materials may be heated individually prior to mixing/combining and potentially subsequently additionally heated to arrive at the desired temperature at which the conducting material lends itself to the interconnection. Alternatively, the materials may be heated once mixed.

Heating may be obtained in a number of manners, such as radiation heating, contact heating, friction, providing the material in an oven, or the like.

The mixing may be a true mixing where the particles and conducting material is stochastically positioned in e.g. a mould. Alternatively, the conducting material may be positioned in a desired manner in relation to the particles.

Another manner of interconnecting is the use of a pressure force forcing the particles into interconnection with the conducting material.

Combinations of the methods clearly may be made.

It may be desired to increase a porosity or effective surface of the layer. In one embodiment, the method may further comprise a step, between the interconnecting step and the lamination step, of providing or increasing a surface porosity in the layer.

Increasing the porosity may be obtained by creating holes or channels in the layer. These need not be through-going but in many situations, this is desired as the ions may then travel through a channel and also engage the opposite side of the layer.

Lasers have been used for this purpose, but they are often too slow for high speed production.

It is preferred that the step of providing the surface porosity comprises feeding the layer over a roller comprising a number of spikes. This lends itself to high speed production. Naturally, two rollers may be provided, one having indentations corresponding to the spikes of the other. This has the advantage that the layer cannot escape the piercing process by riding on the spikes.

It may be preferred that the holes are rather small but that a large number of holes is provided, preferably evenly distributed, so that an even utilization of the opposite side of the layer may be obtained.

The electrode layer may be made as a single layer in a single process. Alternatively, the layer may be made of multiple layers, which may be of the same materials or different materials. In one situation, the different layers are of the same materials but have different parameters. It may be desired to provide layers with different densities and/or with different porosities. Also, different amounts or distributions of the particles and the conductive material may be seen in different layers.

For example, it may be desired that an outer layer has a lower density, which may give better properties as an electrode surface, and another layer has a higher density and/or a larger percentage of the conducting material so as to form a strong basis for the outer layer. The layers may be attached to each other in a number of manners, such as by providing rough surfaces to allow a better connection between the layers. The conductive material of the layers may be used for interconnecting the layers. Rough surfaces may be obtained using screens or calendaring rollers.

As mentioned above, the present invention may result in stronger and more easily handled electrode layers. Then, the method may comprise the step of, subsequent to the shaping step, of rolling the layer on to a roll, and wherein the lamination step comprises feeding the layer from the roll. Thus, this single layer is sufficiently strong to be self-supporting.

As mentioned above, the electrode may be an anode where the particles are of an anode material and where the electrically conducting material comprises cupper, tin, antimony, silicon or alloys comprising such materials.

In addition or alternatively, the electrode may be a cathode where the particles are of a cathode material and the electrically conducting material comprises aluminium, lithium, nickel or magnesium or alloys comprising one or more thereof.

In general, the amount of the electrically conducting material may be selected based on a number of criteria, such as the overall electrical conduction desired, the interconnection desired and the like. Optionally, also the shape of the conducing material may be taken into account as well as the particle size and/or shape of the electrode material. Also the manner of interconnecting the particles may be taken into account.

Also, the step of providing the electrically conducting material could comprise providing an amount of electrically conducting material of between 2 and 40 percent, by volume, of the electrode material.

A final aspect of the invention relates to a method of manufacturing a battery, the method comprising providing a laminate according to the first aspect or manufactured according to the third aspect, providing a casing and providing the laminate inside the casing as well as providing a first and a second terminal of the casing, connecting the first electrode layer to the first terminal and the second electrode layer to the second terminal.

Connection to the terminals may be via tabs or the like. The laminate may be used in the same manner as any other laminate with the difference that the electrical connection to the layer is not to a current collector but to the single layer.

In one embodiment, the step of providing the laminate in the casing comprises folding the laminate before introduction into the casing.

In that or another embodiment, the step of providing the laminate comprises folding the laminate before rolling the laminate.

In the following, preferred embodiments of the invention will be described with reference to the drawings, wherein:

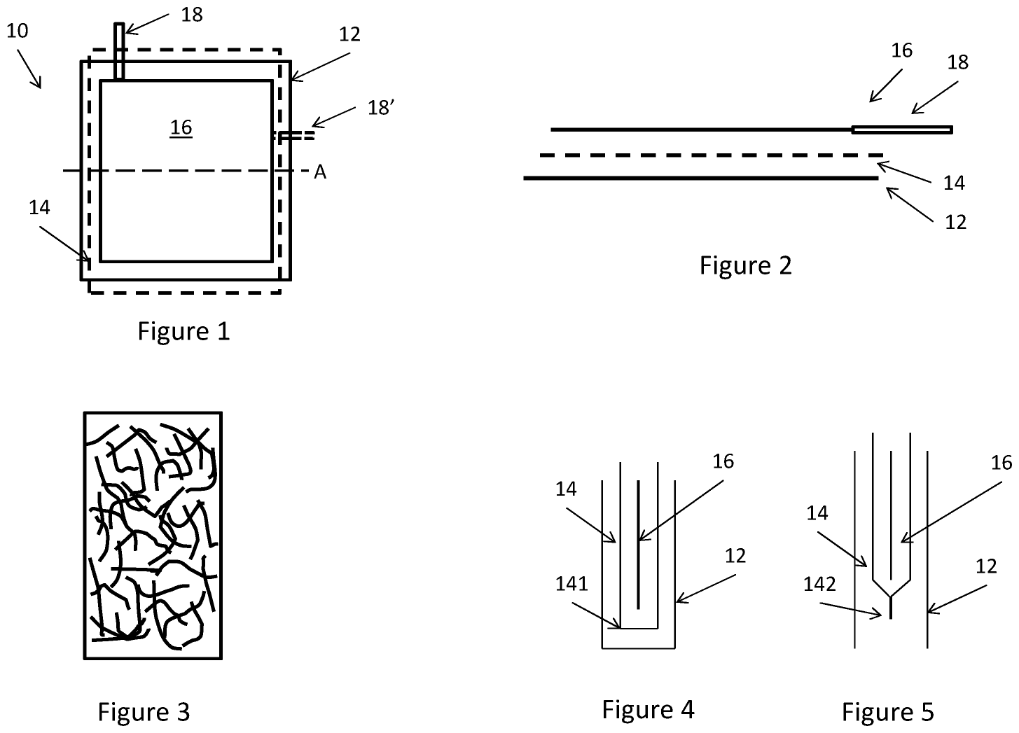

FIG. 1 illustrates a laminate for use in a battery,

FIG. 2 illustrates the laminate from the side,

FIG. 3 illustrates a layer with fibres,

FIG. 4 illustrates a cross section of a first embodiment of a laminate,

FIG. 5 illustrates a cross section of a second embodiment of a laminate, and

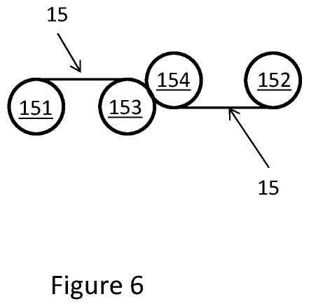

FIG. 6 illustrates a calendaring process.

In FIG. 1, illustrates a laminate 10 for use in a battery, the laminate comprising an anode layer 12, a separator 14 and a cathode layer 16. Preferably, the anode layer is larger than the cathode layer and the separator, which is provided between the anode and cathode, is also larger than the cathode layer. The separator may extend beyond the anode layer in at least one direction and the anode layer preferably extends beyond the separator in at least two opposed directions. The cathode preferably, in this top view when projected on to a plane, is positioned within the outer boundaries of both the anode and the separator.

A tab 18 is provided for connecting to the cathode. A similar tab may be used for the anode.

The layers and the tab are illustrated in FIG. 2 from the side.

This laminate may be rolled as is usual, or folded, and be provided in a battery casing. The electrically conducting material provided inside the layer will act to make the layer stronger so as to not break during folding or rolling.

The laminate may be folded, such as around the axis A, to provided a laminate with the anode layer exposed and with the cathode layer completely provided within the separator which now forms an enclosure for the cathode. This folded assembly is easily cased as the only layer exposed at the lower end and sides is the anode. At the top end, the separator extends out of the roll together with the tab(s). Preferably the tab has a non-conducting surface at least a portion of the distance from the cathode layer to the end the outermost portion may be electrically conducting in order to cater for electrical contacting to the cathode layer. The anode layer may be contacted anywhere on the outer surface. A structure of this type may be seen in the Applicant's co-pending application filed on even date and with the title “A CASING, BATTERY, A METHOD OF MANUFACTURING A BATTERY AND METHODS OF OPERATING THE BATTERY”.

Usually, as is described in the beginning, the anode layer and cathode layer would themselves be laminates of the actual anode or cathode layer, respectfully, and a current collector layer actually carrying the current from/to the layers. Usually, the anode is larger than the cathode and the separator is larger than the anode.

According to the invention, such anode or cathode laminates are replaced by a single anode/cathode layer having therein both the anode/cathode material as well as an electrically conducting material. This has the advantage that only a single layer need be handled.

A layer of this type may be seen in FIG. 3, wherein fibres of the electrically conducting material form a non-woven structure within the layer. Alternatively, fibres may form a woven structure in the layer, or powder/flakes may be added which also will be distributed inside the layer.

Yet another manner would be to sputter the conducting material on to the particles, or use any other manner of forming a layer of the conductor on the particles. The mix may then be heated/pressed. It may be desired to actually mix the particles subsequent to the sputtering (or other process such as plasma arch deposition) in order to randomly direct the portions of the particles having received the conducting material, before activating the conducting material by e.g. heating or pressure.

It is noted that it is possible to control the 3D aspects of optimized electrodes. In conjunction with oblique angle deposition of either Plasma Arch Metal Spray (PAMS) or sputtering and 3D texturing of the outer surface it is feasible to create a freestanding electrode where the current collector functionality also is applied in the process and have openings for electrolyte filling and exchange. Sputtering and PAMS combined with laser fusing can create an unbreakable current collector layer that may only be sub micron thick

The electrically conducting material may be mixed with the electrode material and subsequently heated and/or pressed in order to act as a binder binding the electrode material. Then, the electrically conducting material will be able to replace at least part of the binder historically used in electrode layers. Naturally, the particles and conducting material may alternatively be pre-heated before mixing and layer formation where a last heating or compression is provided to arrive at the desired temperature.

As described above, any type of heating may be used, such as using radiation heat, lasers, radiation, an oven, heated rollers or the like. A combination may even be used where the particles and conducting material may be pre-heated either individually or when mixed, where a last heating step may be carried out to arrive at the desired temperature.

Nevertheless, the electrically conducting material has the additional function of transporting charge created in the anode and cathode layers from the standard transport of ions there between to the terminals of a battery, for example. This is the historic function of the separate current collector layers of historic batteries.

Naturally, any heating may be achieved by a heated roller or rollers. Alternatively, radiation heating may be used. It may be desired that any heating takes place in an inert atmosphere or in vacuum.

Pressure may be achieved between rollers.

In addition, the layers may be made both flexible and durable to be truly free standing. Thus, roll-to-roll processing is possible which has a number of advantages. In this respect, free standing will mean that the layer is able to support its own weight even when travelling between rollers 10 cm apart.

Even though no additional binder is required, it may be desired to increase the porosity of the layer. This may be obtained in a number of manners, one being calendaring. In FIG. 6, a calendaring is illustrated where a layer 15 (anode or cathode) is rolled from one roller 151 between two calendaring rolls 153 and 154 one of which comprises small spikes and the other corresponding indentations, and finally rolled onto another roller 152. The operation of the calendaring rollers 153/4 is to force the spikes into the layer 15 in order to provide indentations or channels therein. These indentations or channels provide a larger surface and a larger porosity for the ions to use during operation of the laminate.

It is noted that naturally, the anode layer and/or cathode layer may be provided as multiple layers. Different layers may have the same constituents but different parameters. A base layer may have a higher hardness and a higher density, such as by having a higher content of the conducting material, whereas an outer layer may have a lower density to cater for a higher surface porosity. The layers may be produced individually and assembled such as by activating the conducting material in the interface between the layers.

It may be desired to provide one or more of these layers with an un-even surface in order to facilitate attachment thereto of another layer.

1.-20. (canceled)

21. A laminate for use in a battery, the laminate comprising:
a first electrode layer,
a second electrode layer and
a separator provided between the first electrode layer and the second electrode layer,
wherein at least one of the first and second electrode layer comprises particles of a predetermined material and an electrically conducting material interconnecting the particles.

22. The laminate according to claim 21, wherein the electrode material is an anode material and the electrically conducting material comprises cupper, tin, antimony, silicon or alloys comprising such materials.

23. The laminate according to claim 21, wherein the electrode material is a cathode material and wherein the electrically conducting material comprises aluminium, lithium, nickel or magnesium or alloys comprising one or more thereof.

24. The laminate according to claim 21, wherein the electrically conducting material comprises between 2 and 40 percent, by volume, of the electrode material.

25. A battery comprising a laminate according to claim 21, the laminate being provided in a casing having a first and a second terminal, the first terminal being connected to the first electrode layer and the second terminal being connected to the second electrode layer.

26. A method of manufacturing a laminate for a battery, the method comprising:
providing particles of a solid electrode material,
providing an amount of a predetermined electrically conducting material,
having the electrically conducting material interconnect the particles to form a first electrode layer,
providing a laminate with the first electrode layer, a second electrode layer and a separator provided between the first electrode layer and the second electrode layer.

27. The method according to claim 26, wherein the step of providing the electrically conducting material comprises providing fibres of the electrically conducting material, and
wherein the interconnecting step comprises providing the fibres as woven structure and providing the particles therein or thereon.

28. The method according to claim 26, wherein the step of providing the electrically conducting material comprises providing fibres of the electrically conducting material, and
wherein the interconnecting step comprises providing the fibres as non-woven structure and providing the particles therein or thereon.

29. The method according to claim 26 wherein the interconnecting step comprises heating the particles and electrically conducting material to have the electrically conducting material act as a binder binding the solid material after cooling.

30. The method according to claim 26, wherein the interconnecting step comprises compressing the electrically conducting material and the particles to have the electrically conducting material act as a binder binding the powder.

31. The method according to claim 26, further comprising a step, between the interconnecting step and the lamination step, of providing a surface porosity in the layer.

32. The method according to claim 31, wherein the step of providing the surface porosity comprises feeding the layer over a roller comprising a number of spikes.

33. The method according to claim 26 comprising the step of, subsequent to the shaping step, of rolling the layer on to a roll, and
wherein the lamination step comprises feeding the layer from the roll.

34. The method according to claim 26, wherein the step of providing the particles and the electrically conducting material comprises providing, as the particles, an anode material and, as the electrically conducting material, cupper, tin, antimony, silicon or an alloy comprising at least one thereof.

35. The method according to claim 34, wherein the step of providing the electrically conducting material comprises providing between 10 and 40 percent, by volume, of the anode material.

36. The method according to claim 26, wherein the step of providing the particles comprises providing a cathode material and
wherein the step of providing the electrically conducting material comprises providing aluminium, nickel or magnesium or alloys comprising one or more thereof.

37. The method according to claim 36, wherein the step of providing the electrically conducting material comprises providing between 10 and 40 percent, by volume, of the cathode material.

38. The method of manufacturing a battery, the method comprising providing a laminate according to a laminate for use in a battery, the laminate comprising:
a first electrode layer,
a second electrode layer and
a separator provided between the first electrode layer and the second electrode layer,
wherein at least one of the first and second electrode layer comprises particles of a predetermined material and an electrically conducting material interconnecting the particles;
or manufactured according to claim 26, providing a casing and providing the laminate inside the casing as well as providing a first and a second terminal of the casing, connecting the first electrode layer to the first terminal and the second electrode layer to the second terminal.

39. The method according to claim 38, wherein the step of providing the laminate in the casing comprises folding the laminate before introduction into the casing.

40. The method according to claim 38, wherein the step of providing the laminate comprises folding the laminate before rolling the laminate.
